(19) United States
(12) Patent Application Publication
(10) Pub. No.: US 2003/0170507 A1
(43) Pub. Date: Sep. 11, 2003

(54) Device and method for producing and simulating two-phase flows in chemical and electrochemical reactors, or in heat exchangers

(76) Inventors: Hendrik Dohle, Stolberg-Mausbach (DE); Thomas Bewer, Aachen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/380,021

(22) PCT Filed: Sep. 7, 2001
(86) PCT No.: PCT/DE01/03432

(30) Foreign Application Priority Data
Sep. 8, 2000 (DE) 100 44 571.3

(51) Int. Cl. H01M 8/00

(52) U.S. Cl. 429/12

(57) ABSTRACT

The invention relates to a device for producing and simulating two-phase flows. The device is at least partially transparent, thereby allowing observation of the interior of the device. Two-phase flows, such as occur for example in fuel cells, heat exchangers or other chemical or electrochemical reactors can be easily simulated if such a device forms part of a fuel cell, a heat exchanger or another reactor. The invention further relates to a method for producing and simulating two-phase flows in an electrochemical or chemical reactor, such as fuel cells, comprising the following steps: introducing a gas-emitting solution into an at least partially transparent device that comprises means for producing two-phase flows, and producing and recording the two-phase flow.

The invention relates to a device and a method of producing and simulating two-phase flows in chemical or electrochemical reactors, especially fuel cells, and in heat exchangers.

Chemical and electrochemical reactors serve to supply reaction partners to a reaction zone, to carry out chemical electrochemical reactions and to carry off reaction products from the reaction zone. Energy can be supplied for that purpose or can be liberated. The energy types can include both thermal energy and electrical energy. This applies especially also to fuel cells and heat exchangers. There multiphase regions can arise which can lead to loss of function.

In the case of a fuel cell electrical energy is recovered directly from a fuel and oxidizing medium. The fuel cell is comprised of a cathode, an anode and an electrolyte lying between them. To the cathode an oxidizing medium (for example, air) and to the anode a fuel (for example methanol) can be fed. The cathode and anode of the fuel cell have as a rule a continuous porosity so that the two operating media (fuel and oxidizing medium) can be supplied to the electrolyte and the reaction product can be carried off.

Carbon dioxide is a typical reaction product at the anode side. A plurality of fuel cells are as a rule electrically and mechanically connected together by connecting elements, so-called interconnectors, to produce greater electrical powers. An example of a connecting element is the bipolar plate. By means of interconnectors, fuel cells can be stacked one above another and connected electrically in series. These arrangements are called fuel cell stacks. The fuel cell stack is comprised of the interconnectors and the electrode-electrolyte units.

Interconnectors have, apart from the electrical and mechanical characteristics, usually also distributor structures for the operating media. With the bipolar plate, these ribs for electrode contacts, and separate the channels for supplying the electrodes with operating media from one another (DE 44 10 711 C1). Distributor structures like manifolds, channels in bipolar plates, holes in contact plates, meanders or small feet of a mesh or grid, effect a uniform distribution in the electrode space (compartment in which the electrode is found).

In a so-called “Direct Methanol Fuel Cell” (DMFC) methanol together with water is distributed on the anode by such distributor structures and with the aid of catalysts, like for example platinum-ruthenium alloys, can be converted to protons and carbon dioxide. A two-phase flow is formed where CO₂ arises in a liquid. The transport of liquid and gaseous substances in a porous system occurs very differently. If a liquid and a gas-forming phase are adjacent one another, a gas transport occurs substantially only through the pores which are not wetted with liquid. The liquid filled pores as a general matter, cannot be passed by the gas.

A disadvantage which arises in the operation of a DMFC with liquid fuel (a methanol-water mixture) with carbon dioxide is that a second gas-forming phase develops. In the direct vicinity of the electrolyte, the carbon dioxide which is formed must leave the reaction region through the pores of the anode. This hinders the uniform supply of liquid fuel to the electrolyte.

On the grounds mentioned, the carbon dioxide which arises must be conducted away as a gaseous reaction product from the anode compartment in the operation of the fuel cell since otherwise the gas bubbles, inter alia can lodge in the distributor structures, thus for example in the channels of the bipolar plates and there effect a reduction of the power output of the fuel cell.

In heat exchangers, in a similar manner, two phase flow can arise in the form of bubble formation by water evaporation. In this case a problem can arise because the bubble formation may result in a blockage of the heat transfer which can give rise to a decrease in the efficiency of the heat exchanger.

Visibility and simulation, in the generation of two phase flows, is thus of great interest, as to the manner in which they arise in fuel cells, heat exchangers or other chemical reactors. The two phase flow triggering means, for example, the distributor structures and catalysts can then be used to influence the gas development and flow of the gas in the liquid.

An exact determination of the flow processes in the interiors of fuel cells, heat exchangers or other reactors, like electrolyzers and accumulators [storage batteries] is thus required. These however because they have additional current-conducting structures and because of the materials involved as a rule are present in closed systems, are optically inaccessible. An exact determination of the flow processes in operation cannot be obtained.

The object of the invention is to provide a device with means for producing and simulating two phase flows. As a condition of the investigation, it is essential to render the two phase flow visible.

The object is achieved with a device having features of the main claim. Advantageous configurations are given in the claims which depend therefrom.

The device encompasses means for producing a two-phase flow and which is at least partly transparent. As a result a view of its interior is ensured. Two-phase flows, for example the flow changes resulting from gas bubble formation in or of liquids, are thus visible. The device itself can be a more or less true representation of a chemical or electrochemical reactor or the like which has a two-phase flow basis. It encompasses the means for producing the two-phase flow and the means for testing it.

Advantageously, the device is of modular construction. As a result the device is extraordinarily flexible. Individual parts of the device can be easily replaced and renewed.

The device can be composed at least partly of plexiglass. Plexiglass is economical. It is simple to work with. Structures which are close to reality as can be required in the development of simulator reactors can be easily fabricated therefrom.

The invention can be embodied as a means for producing two-phase flows with a distributor structure with feed and discharge lines both for the distribution of liquids and gases. The distributor structure of the device can, for example, be in the form of manifolds or channels as in a true fuel cell. The device can then be a replica of a fuel cell. It allows two-phase flows to be produced therein and to simulate the flow conditions within a fuel cell. The device encompasses at least such means for testing which participate in the production of the two-phase flow and which can be used to test their influence on the two-phase flow.

Especially advantageous is a device of this type which also includes catalysts. The catalysts which can be used can be those which are appropriate for the liberation of gases from solutions at those locations in the device at which gases evolve in the operation of the real fuel cell, for example a DMFC, or a real heat exchanger. The simulation of the two-phase flow is therefore more exact.

The object is achieved in addition in a method for producing and simulating two-phase flows in chemical or electrochemical reactors. It encompasses the steps of:

feeding a gas liberating solution into an at least partly transparent device with means for producing a two-phase flow,

generating the two-phase flow and registering it.

The method can especially be used for fuel cells, fuel cell stacks and heat exchangers.

Without limitation of the invention, the invention can be embodied as a method also for the simulation of two-phase flows in electrolyzers, accumulators, diaphragm cells and reactors for electrochemical waste water treatment. The device used is a more or less complete replica of the mentioned reactors. It encompasses all means which participate in the production of the two-phase flow and which influence the two-phase flow and can be tested, for example, in distributor structures and catalysts.

The registration can be especially a visual process as is meant with the use of video cameras. Without limitation of the invention, however, other registration processes, for example processes for the registration of pressure changes or volume changes, can be used.

Advantageously, dilute H₂O₂ is fed to the reactor as a gas-liberating solution. It is economical, colorless and with the use of a platinum-ruthenium composition as catalyst, is easily converted to oxygen and water. The oxygen which is produced as a reaction product is a gas which can be released into the environment without concern. The oxygen is generated at the same places as in the actual functioning fuel cell, namely, at the catalyst.

Especially preferred is the use of an H₂O₂ concentration of 0.5 to 30% and especially 2 to 5%. The H₂O₂ concentration thus results in a gas bubble formation which corresponds to the actual conditions for gas bubble formation in a DMFC fuel cell. With the use of higher H₂O₂ concentrations, the quantities of catalyst needed can be held low. Expensive noble metals are thereby conserved.

As an example, the production of a two-phase flow and its simulation as in a DMFC fuel cell is mentioned. The housing of the device is comprised of plexiglass which ensures a view of the interior. The device includes in addition a catalyst layer of platinum-ruthenium in a coating of 2 mg/cm² and a gas distributor structure in the form of manifolds as well as channels and ribs, as in a bipolar plate, with widths each of 2 mm. As the gas-liberating solution, 3% H₂O₂ solution is used. The gas bubble formation corresponds to that which arises in operation of a direct methanol fuel cell at a current density of 100 to 500 mA/cm². A colored solution, especially containing the food coloring E124, can be used. In this manner the observability of the flow patterns of the liquid phase are improved. The flow of gas in the liquid or the flow of liquid itself can be recorded easily with a video camera and investigated in detail. The development of suitable structures, for example distributor structures, at which a gas-like carbon dioxide does not collect, is facilitated as is the discharge of the gas.

A further example is that of a transparent model of a heat exchanger in which one controls the simulated two-phase flow and makes visible the region with a higher thermal input by coating it with platinum-ruthenium in a layer of 2 mg/cm² of this catalyst material. As a consequence when 3% H₂O₂ is used as a gas-liberating solution, only in these regions are gas bubbles formed, as in the case of a fuel cell based upon the simulation of the flow conditions. Knowledge can be obtained for the development of a heat exchanger with a planned arrangement of its internal components to minimize gas bubble development and thus increase the efficiency.

1. A device for simulating a two-phase flow whereby the device is at least partly transparent and for generating the two-phase flow encompasses distributor structures for the liquid and gas, characterized by at least one catalyst or producing gas from a gas-liberating solution.

2. The device according to claim 1, characterized in that it is comprised at least partly of plexiglass.

3. The device according to one of the preceding claims, characterized by distributor structures in the form of manifolds, channels and ribs.

4. The device according to one of the claims 1 or 2, characterized by distributor structures in the form of meanders or little feet of a mesh or perforation in contact plates.

5. The device according to one of the preceding claims, characterized by platinum-ruthenium as the catalyst.

6. A heat exchanger model as the device according to one of claims 1 to 5.

7. A fuel cell or fuel-cell stack model as the device according to one of claims 1 to 5.

8. A method for producing and simulating two-phase flows in an electrochemical or chemical reactor, characterized by the steps of:
a gas-liberating solution is fed to a device according to one of claims 1 to 5 or to a heat-exchanger model according to claim 6 or to a fuel cell or fuel-cell stack model according to claim 7,
the two-phase flow is produced and registered.

9. The method according to claim 8, characterized by dilute H₂O₂ as the gas-liberating solution.

10. The method according to claim 8 or 9, characterized by an H₂O₂ concentration of 0.5 to 30%, and especially to 2 to 5%.
